(19) United States
(12) Patent Application Publication
(10) Pub. No.: US 2003/0154202 A1
(43) Pub. Date: Aug. 14, 2003

(54) Distributed data system with process co-location and out -of -process communication

(76) Inventors: Darpan Dinker, San Jose, CA (US); Mahesh Kannan, San Jose, CA (US); Pramod Gopinath, Union City, CA (US)

Correspondence Address: Robert C. Kowert, Conley, Rose, & Tayon, P.C., P.O. Box 398, Austin, TX, 78767, US

(21) Appl. No.: 10/074,092

(22) Filed: Feb. 12, 2002

(51) Int. Cl. G06F 7/00

(52) U.S. Cl. 707/100

(57) ABSTRACT

A distributed system may include different nodes having different distributed data management configurations in the same distributed data system. A node may include a distributed data manager in a process space for handling requests for data storage and retrieval from clients to the distributed data system. A client may share the same process space in some nodes and may have a distinct process space from a distributed data manager in other nodes. The distributed data system enables the transmission of serialized data among nodes. Nodes in the same distributed data system may store distributed data in serialized or deserialized format depending on their configuration. Various functionalities, such as load balancing or high availability may be implemented using the distributed data system.

### BACKGROUND OF THE INVENTION

1. Field of the Invention

The present invention relates to a distributed data system (DDS), and more particularly to the process configuration for nodes in clustered distributed data systems.

2. Description of Related Art

Distributed Data Systems manage data owned by members of a distributed system formed in a network. By managing the data, a distributed data system provides abstraction of data locality to data users, or clients, that are connected to member systems, or nodes, of the distributed system. Fault tolerance can be provided by clustering a distributed data system and the implementation of high availability through replicating or distributing data. Each node in such a cluster may have one or more clients depending on the topology of the cluster and its configuration.

Several factors have been considered when deciding the topology and configuration of clustered distributed data systems. The footprint of clients, their needed amount of some resources such as memory, and the number of clients impact the load on the distributed system and its members. Whether clients can communicate directly with different nodes in a cluster and the amount of communication expected also influence the design of the topology and the configuration of a cluster. In conventional distributed system, depending on the balance of factors, the nodes in a cluster are all configured alike.

FIG. 1 illustrates one distributed data system configuration, which includes distributed data manager nodes 111 coupled together and to clients 101. Each distributed data manager 111 includes a data store 121 providing data storage for distributed data within the distributed data system. The distributed data manager nodes 111 and the clients 101 execute as different processes. This configuration is referred to as out-of-process and all nodes in the distributed data system in this configuration are configured out-of-process. Each distributed data manager may be considered a node of the out-of-process cluster.

Referring to FIG. 1, in the out-of-process configuration a cluster comprises a plurality of distributed data manager nodes 111 and a plurality of client nodes 101. Each distributed data manager node 111 may operate on a different machine in a network. Each client 101 may communicate with an associated distributed data manager node 111 (e.g. one executing one the same machine). As needed, a distributed data manager node may communicate with the other distributed data manager nodes in the cluster to respond to the requirement of clients and to perform distributed data functions (e.g. replication for availability, load balancing, etc.).

For example, referring to FIG. 1, when client 101B1 generates data, client 101B1 may send the data to distributed data manager 111B on the same machine. Distributed data manager 111B may then store the data in its data store 121B and transmit the data to another node in the cluster to provide a back-up at a remote location, for example distributed data manager 111C. Providing fault tolerance for high availability may require multiple copies of the same data present at any point in time in the cluster. When client 101B1 accesses data, it may request the data from the distributed data manager 111B on the same machine. If the requested data is present in the data store 121B of the distributed data manager 111B, the requested data is returned to the client 101B1. Otherwise, the distributed data manager 111B requests the data from another distributed data manager in the cluster, for example distributed data manager 111C. When another distributed data manager finds the requested data, that distributed data manager transmits the requested data to the requesting distributed data manager 111B. The requesting distributed data manager 111B then stores the data in its data store 121B and transmit the requested data to the client 101B1.

In the out-of-process configuration as shown in FIG. 1, data crosses process boundaries when transmitted among distributed data managers 111 or between distributed data managers 111 and clients 101. To transmit data across process boundaries, data is serialized before transmission, transmitted and received in its serialized format, and de-serialized at the receiving end.

Serializing data involves collecting data, such as objects with associated attributes, variables and identification of methods and/or classes, into transmittable data. For example, serialization may include generating object data sequentially so that it may be transmitted as a data stream. The serialized data represents the state of the original data in a serialized form sufficient to reconstruct the object. De-serializing involves producing or reconstructing the original object data from its serialized format.

FIG. 2 illustrates a second distributed data system configuration, which includes nodes coupled together to form a distributed data system. Each distributed data manager 211 includes a data store 221 providing data storage for distributed data within the distributed data system. In this configuration, each of the distributed data manager 211 shares a process space with one of clients 201. This configuration is called in-process and all nodes in the distributed data system in this configuration are configured in-process. Each of the combined distributed data manager and client pair processes forms a node of the in-process cluster.

Referring to FIG. 2, in the in-process configuration a cluster comprises a plurality of nodes including in each process space a distributed data manager and one or more associated client processes. Each node may operate on a different machine in a network but all are configured as in-process nodes. Clients 201 may access directly the data store 221 present in the distributed data manager 211 sharing the same node. As with the out-of-process configuration, a distributed data manager may communicate with the other distributed data managers in the cluster to respond to the requirements of a client and to perform distributed data functions.

Referring to FIG. 2, when a client generates data, the client may store the data in the data store of its corresponding distributed data manager. The distributed data manager may then transmit the data to another node in the cluster to provide a back-up at a remote location. When a client 201 accesses data, it accesses the data store 221 for example. If the requested data is present, the requested data is available to the client. Otherwise, for example, a client 201A requests the data from the distributed data manager 211A. Distributed data manager 211A requests the data from another distributed data manager in the cluster, such as distributed data manager 211B. When another distributed data manager finds the requested data, that distributed data manager transmits that data to the requesting distributed data manager. The requesting distributed data manager 211A then stores the data in its data store 221A and returns the data or a pointer to the client 201A indicating where the requested data is in the data store 221A.

In the in-process configuration as shown in FIG. 2, data crosses process boundaries when transmitted between nodes but not when transmitted between a distributed data manager and a client within the same node. Therefore, although serialization and de-serialization take place across process boundaries, in the in-process configuration data may be communicated between a distributed data manager and a client sharing the same process space, without the additional computation requirement for serialization/deserialization.

Conventional systems allow only one type of configuration—either every node is an in-process node or every node is an out-of-process node. For example, if an out-of-process client is desired, then all other clients would also need to be configured as out-of-process clients.

### SUMMARY OF THE INVENTION

The system and method provide for the simultaneous use of different node configurations for distributed data management within the same distributed system. In one embodiment, different nodes in the same distributed system operate using different data management configurations. For example, one distributed data manager in a cluster may share its process space with a client(s) while another distributed data manager may be out-of-process from its clients.

In one embodiment, client processes may access data through a distributed data manager whether or not the client and distributed data manager share the same process space. The client processes may be shielded from the implementation details of data operations, such as data storage or retrieval, regardless of the configuration of an associated distributed data manager. A distributed data manager may handle data differently in response to data operations by a client depending on the configuration status of the distributed data manager.

In one embodiment, data access or data store requests between a client process and a distributed data manager that share the same process space in a cluster node may avoid serialization/deserialization overhead. For example, objects may be accessed with pointers or object references. The distributed data manager may serialize the data for transmission to other nodes in the cluster. In one embodiment, data is serialized before transmission between a process and a distributed data manager that do not share the same process space.

If requested data is not available from a local distributed data manager, for example, the distributed data manager may request the data from another distributed data manager in the distributed system. Since the requested data crosses process boundaries, the distributed data manager receives the relevant data in serialized format. Upon receiving the requested data from some other distributed data manager, a distributed data manager may store a copy within its process space. A distributed data manager sharing its process space with a client process may de-serialize the data while a distributed data manager not sharing its process space may store the data serialized.

In one embodiment a distributed data system includes a plurality of nodes coupled together in a network. The nodes may communicate data between each other over the network. At least one of the nodes may be an in-process node and at least one of the nodes may be an out-of-process node. An in-process node may include an in-process client and a distributed data manager that share the same process space. The distributed manager and in-process client are configured to communicate data between each other in a non-serialized format. The distributed data manager is configured to communicate data with other nodes or processes in a serialized format. An out-of-process node may be an out-of-process client that executes in a process space not shared with a distributed data manager. The out-of-process client may communicate data in a serialized format with other processes or nodes.

In one embodiment an in-process client and an out-of-process client may operate in a distributed data system as follows. The in-process client may execute in the same process space of an in-process node in the distributed data system as a distributed data manager for the in-process node. The in-process client may request data from the distributed data manager. If the requested data is present in a data store managed by the distributed data manager for the in-process node, the distributed data manager may return the requested data to the in-process client without serializing the data. If the requested data is not present in the data store managed by the distributed data manager for the in-process node, the distributed data manager may retrieve the requested data in a serialized format from another node of the distributed data system, deserialize the data and return the requested data to the in-process client. When returning requested data, the distributed data manager may return a data pointer or an object reference indicating where the data is stored in the data store it manages. The out-of-process client may request data from a node within the distributed data system and receive that requested data in a serialized format.

In one embodiment, an in-process client and an out-of-process client may operate in the same distributed data system as follows. The out-of-process client executing in a process space distinct from a distributed data manager may request data from the distributed data manager for an out-of-process node of the distributed data system. If the requested data is present in a data store managed by the distributed data manager for the out-of-process node, the distributed data manager for the out-of-process node may return the requested data to the out-of-process client as a serialized object. If the requested data is not present in the data store managed by the distributed data manager for the out-of-process node, the distributed data manager for the out-of-process node may retrieve the requested data in a serialized format from another node of the distributed data system and return the requested data in a serialized format to the out-of-process client. An in-process client may execute in the same process space of an in-process node in the distributed data system as a distributed data manager for the in-process node. The in-process client may request data and receive the requested data from the distributed data manager for the in-process node in de-serialized format.

### BRIEF DESCRIPTION OF THE SEVERAL VIEWS OF THE DRAWINGS

FIG. 1 illustrates an out-of-process cluster configuration for a distributed data system;

FIG. 2 illustrates an in-process cluster configuration for a distributed data system;

FIG. 3 illustrates a distributed data system according to one embodiment of the present invention;

FIG. 4 is a flowchart illustrating an in-process distributed data manager handling a data request from a client within an in-process node;

FIG. 5 is a flowchart illustrating an in-process distributed data manager handling a request to store data from a client within an in-process node;

FIG. 6 is a flowchart illustrating an out-of-process distributed data manager handling a data request from an out-of-process client; and

FIG. 7 is a flowchart illustrating an out-of-process distributed data manager handling a request to store data from an out-of-process client.

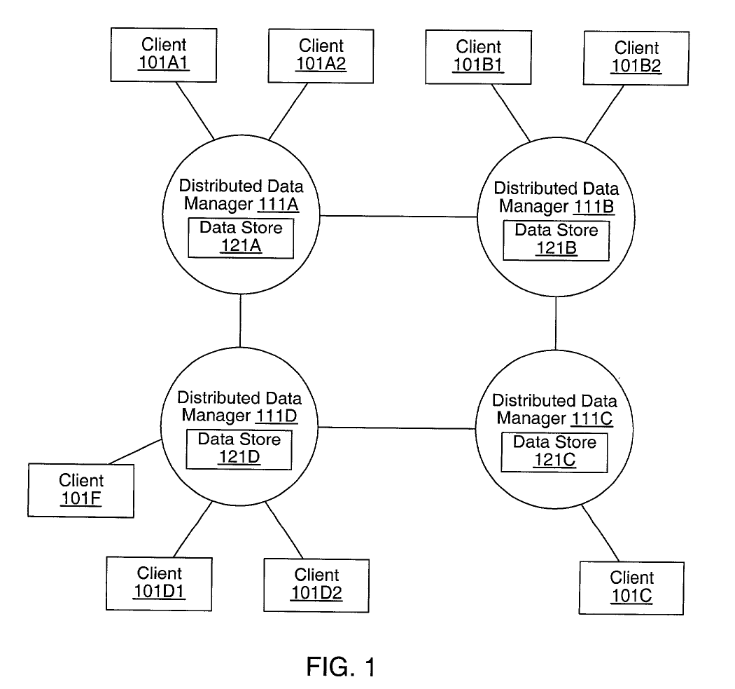

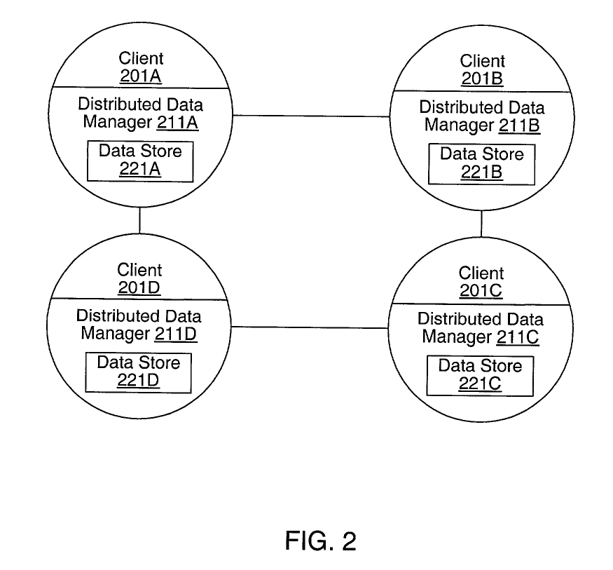

While the invention is described herein by way of example for several embodiments and illustrative drawings, those skilled in the art will recognize that the invention is not limited to the embodiments or drawings described. It should be understood that the drawings and detailed description are not intended to limit the invention to the particular form disclosed but, on the contrary, the intention is to cover all modifications, equivalents, and alternatives falling within the spirit and scope of the present invention as defined by the appended claims. The headings used are for organizational purposes only and are not meant to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION OF THE INVENTION

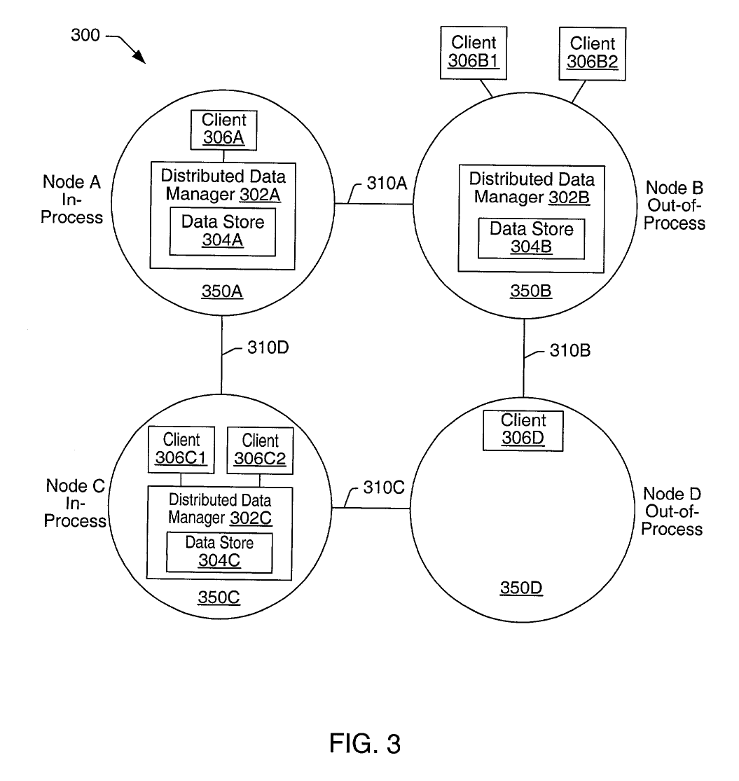

FIG. 3 illustrates a distributed data system 300 according to one embodiment. Four nodes of the distributed data system, nodes A-D, are illustrated coupled together in a ring topology using links 310. Links 310 may be a network connection between the nodes. Note that while only four nodes are illustrated, the distributed data system may include fewer or more nodes. Also, it is noted that while the nodes are illustrated as coupled in a ring topology, any other suitable network topology for a distributed data system may be employed. Each node may be implemented on a computing device, such as a server, computer, workstation, desktop, mainframe, laptop, hand-held device, etc. The nodes are networked together (e.g. through a LAN, WAN, the Internet, wireless network, etc., or combination thereof) to communicate data between nodes. Some nodes may include a distributed data manager 302 configured to implement a distributed data management system among the nodes. For example, the distributed data managers 302 within the nodes may ensure data availability for the system 300 by replicating data stored in a node on one or more other nodes. If a node fails, one or more nodes storing the replicated data from the failed node may service requests for that data in order to maintain data availability, and may recreate the failed node. Distributed data managers 302 may also provide for node balancing and other data management functions as are found in conventional distributed data systems.

One or more clients 306 may be associated with each node. A client may be an application, applet, servlet, bean, etc. that uses, creates, or manipulates data within the distributed data system 300. For example, in one embodiment a client 306 may be a web server handling web page requests received over an Internet connection. The distributed data manager 302 for the client's node may be comprised within an application server coupled to the web server client. In other embodiments, a client may be any client for managed data within a distributed data system, and the distributed data managers 302 may be stand-alone components or implemented as part of a server or any other suitable configuration for a distributed data system.

Each node is configured as either an in-process node or an out-of-process node. For example, in FIG. 3 nodes A and C are configured as in-process nodes and nodes B and D are configured as out-of-process nodes. If a node is configured as an in-process node, the client(s) 306 for that node execute within the same process as the distributed data manager 302 for that node. If a node is configured as an out-of-process node, the client(s) 306 for that node execute within a separate process. For out-of-process node B, the associated clients 306B1 and 306B2 may also be considered to be separate out-of-process nodes. As will be explained in further detail below, by allowing both in-process and out-of-process configurations, data communication efficiency may be improved while allowing increased node configuration flexibility.

The manner by which data is communicated within the distributed data system 300 depends upon the type of node handling the data communication. All distributed data communications between nodes and all distributed data communications for out-of-process nodes cross a process boundary. Therefore, the object being communicated is serialized by the sending process and then sent in a serialized format to the requesting node or client. Also, data received and stored by a distributed data manager 302 for an out-of-process node may be stored in a serialized format since any later requests for that data will be out-of-process requests. For in-process nodes, data communications may be handled within the node without serialization/deserialization since the clients and distributed data manager execute within the same process. For distributed data communications in an in-process node, data may be passed in object format or as an object reference without any serialization or deserialization. Several examples are given as follows to highlight how data requests are handling for in-process and out-of-process nodes.

When a client within an in-process node stores data in the in-process node, the data store request may be sent to the distributed data manager for that node. For example, referring to FIG. 3, client 306A may request a data store operation to distributed data manager 302A in in-process node A. Client 306A and distributed data manager 302A both execute within the same process 350A. Distributed data manager 302A is configured to operate in an in-process mode. Thus, the data for the data store operation may be passed from client 306A to distributed data manager 302A as an object or merely as an object reference. Distributed data manager 302A may store the object or object reference in its data store 304A. Since client 306A and distributed data manager 302A operate within the same process 350A, no extra serialized copy of the data need be created for local storage in data store 304A. A serialized copy may be created for distributed storage within another node since the data will be transmitted to another node through an out-of-process communication. For example, distributed data manager 302A may generate a serialized copy of the data for transmission to distributed data manager 302B.

A client may request data within its local node. For example, client 306A may request data from distributed data manager 302A. Since distributed data manager 302A is configured to operate in the in-process mode, it returns the requested data to client 306A in an object format or as an object reference. If the requested data is present in data store 304A of the distributed data manager 302A, the data object may be returned without need to access another node. However, if the requested data is not locally stored by distributed data manager 302A, distributed data manager 302A will retrieve the requested data from another node. Since retrieving the requested data from another node involves an out-of-process communication, the requested data will be received by distributed data manager 302A in a serialized format. Distributed data manager 302A will deserialize the received data into an object format storing the object in its data store 304A and returning the object or object reference to the requesting client 306A.

When a client communicates with an out-of-process node, the communication will involve serialization/deserialization of data since the communication crosses process boundaries. For example, referring to FIG. 3, to store data in its out-of-process node, out-of-process client 306B1 would serialize the data and send it to its local distributed data manager 302B in out-of-process node 350B. Distributed data manager 302B would receive the serialized data and store data in its data store 304B. In one embodiment, if the distributed data manager 302 is configured for out-of-process mode, the data would be stored “as is” in its serialized format.

If an out-of-process client requests data, the data may be returned to the client in serialized format and the client will deserialize the data. For example, client 306B2 may request data from its local distributed data manager 302B. If the data is present in local data store 304B, distributed data manager 302B will return the serialized data to client 306B2. Note that since the data may already be stored in serialized format, distributed data manager 302B will not need to perform additional serialization on the data (although some serialization may be required for other message components in the communication between distributed data manager 302B and client 306B2). If the requested data is not locally present it may be requested from another node. The requested data will be received in a serialized format from another node having the data. The data may then be locally stored “as is” (serialized) by distributed data manager 302B and returned to client 306B2.

Some nodes may not include a distributed data manager 302. For example, node D of FIG. 3 illustrates an example of a node that does not include a distributed data manager. However, such nodes may still include one or more clients 306. Such nodes will essentially operate as out-of-process nodes since the clients will have to communicate across process boundaries to access data in the distributed data system. Such clients may have their own local data stores that are not part of the distributed data system (e.g. do not participate in the data availability, load balancing, etc. functionality provided by distributed data managers 302). Such out-of-process nodes will receive and send data to other nodes in the distributed data system in serialized format.

In one embodiment of the distributed data system 300 each node is not aware of the operating mode (in-process or out-of-process) of the other nodes. Each node may be responsible for handling data accesses according to its configuration. A node does not need to be aware of the node configuration when communicating with other nodes since all inter-node communications cross process boundaries and thus involve serialization of data at the sending node. It may be up to the receiving node to decide how to handle the data according to whether or not the node is an in-process or out-of-process node.

Thus, when data is received at a receiving node, it may be the responsibility of that node to ensure that the data is stored correctly into its data store. If the receiving node is operating in the in-process mode then the distributed data manager for that node may deserialize the data to recreate the object and then store the object in its data store. If the receiving node is in the out-of-process mode, the serialized data may be stored “as is” in the local data store, in one embodiment.

When a client requests data from the distributed data manager 302 for a node, the distributed data manager 302 may first check to see if the requested data is present in its data store 304. If a match is found then the operating mode of the distributed data manager may determine the manner in which the data is returned to the client. If the distributed data manager 302 is in the in-process mode then the data may be returned back to the client as an object. If the distributed data manager is operating in the out-of-process mode, the data is returned to the client in a serialized format. The client may then have to deserialize the data to reconstruct the object. If a distributed data manager 302 is not able to find the requested data in its data store, then it may request the data from the other nodes in the distributed data system topology. If the data is found in any of the other nodes then it may be transferred from that node to the requesting node in serialized format. The requesting node may then store the data in its data store (according to the operating mode for that node) and send the data to the requesting client.

Thus, a distributed data system may include nodes configured to operate in either an in-process or an out of-process mode. The operating mode for each node may determine how data communications are handled within that node. For example, the manner in which data requests are handled for clients of that node and the manner by which data is stored in the node may depend on the operating mode of the node. A distributed data manager within a node may be configured to operate according to the in-process or out-of-process mode and handle client data operations accordingly. The distributed data manager may also perform data replication operations to other nodes to ensure availability and perform other distributed data functions with other nodes, such as load balancing, etc.

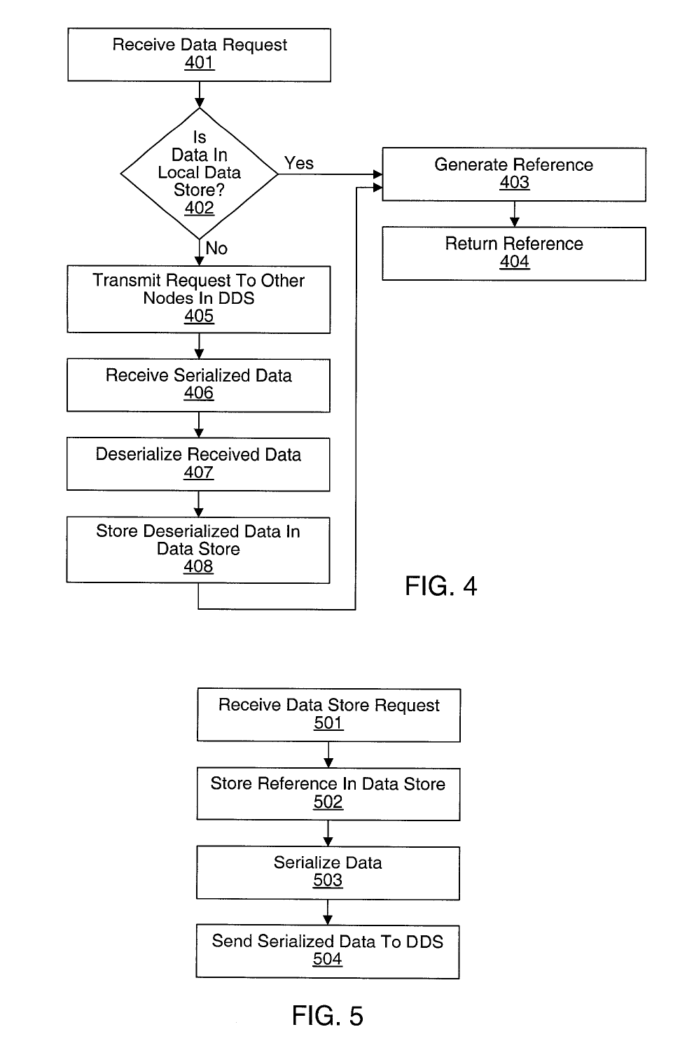

FIG. 4 is a flowchart illustrating an example of an in-process distributed data manager handling a data request from a client within an in-process node. Following FIG. 3, for example, a client 306A transmits data request to the distributed data manager 302A on the same node, providing an indication of which data is requested from the distributed data system. The distributed data manager 302A receives the data request, as indicated at 401. The distributed data manager 302A then checks its data store 304A or some data structure containing information about the contents of the data store 304A to determine if the requested data is in the data store 304A, as indicated at 402. If the requested data is available locally 402, the distributed data manager 302A generates a reference, such as an object pointer, indicating where the requested data is stored in the local data store 304A, as indicated at 403. The distributed data manager 302A then returns the reference to the client 306A, as indicated at 404. Since the client 306A and the distributed data manager 302A share the same process space, client 306A may then access the requested data directly from the data store without need of creating an extra copy.

In the event that the requested data is not available locally 402, the distributed manager 302A transmits a data request for that data to other nodes in the distributed data system 300. For example, distributed data manager 302A transmits 405 a data request to distributed data manager 302B of node B. If the requested data is in its data store 304B, distributed data manager 302B returns that data to distributed data manager 302A of node A. Since node B is out-of-process, the data in the data store 304B of distributed data manager 302B is already serialized and therefore does not need to be serialized before transmission. Distributed data manager 302A then receives the serialized data requested, as indicated at 406. Distributed data manager 302A deserializes the serialized data received, as indicated at 407, and stores the deserialized data in its data store, as indicated at 408. Since the data is now available locally, the distributed data manager 302A and client 306A may proceed as described above, as indicated at 403, when the requested data is available from the local data store.

The requested data may not be available from an out-of-process node in the distributed data system 300, as in the example above, but available from an in-process node, such as node C. In the case of an in-process node responding to the request of another node in the distributed data system the data is serialized before transmission. For example, after distributed data manager 302C receives the data request from distributed data manager 302A and determines the data is available from its local data store 304C, distributed data manager 302C serializes the requested data and transmits it to node A for distributed data manager 302A. Distributed data manager 302A may then proceed as above, as indicated at 406.

FIG. 5 is a flowchart illustrating an example of a distributed data manager handling a data store from a client within an in-process node. Following FIG. 3, for example, an in-process client 306A transmits a data store request to the distributed data manager 302A on the same node, providing an indication of which data is to be stored into the distributed data system. The distributed data manager 302A receives the data store request indicating data, an object, to be stored, as indicated at 501. The data store request may include an object reference or the object itself. The distributed data manager 302A may then store the object in its data store 304A, as indicated at 502. Since the distributed data manager 302A and client 306A share the same process space 350A, the data store need not contain an extra copy of the data. The distributed data manager 302A may thus store an object reference in its data store 304A, as indicated at 502. If data replication on another node is desired, the distributed data manager 302A then serializes the data to be stored in the distributed data system 300, as indicated at 503. The serialized data is then transmitted to at least one other node in the distributed data system 300, as indicated at 504. Any other distributed data manager 302 receiving the serialized copy of the data may store that copy in their data store 304, depending on their own configuration. For example, distributed data manager 302B would store the data received “as is” in its data store 304B since it is configured out-of-process and the data is already serialized. Alternatively, distributed data manager 302C would deserialize the data received before storing it in its data store 304C.

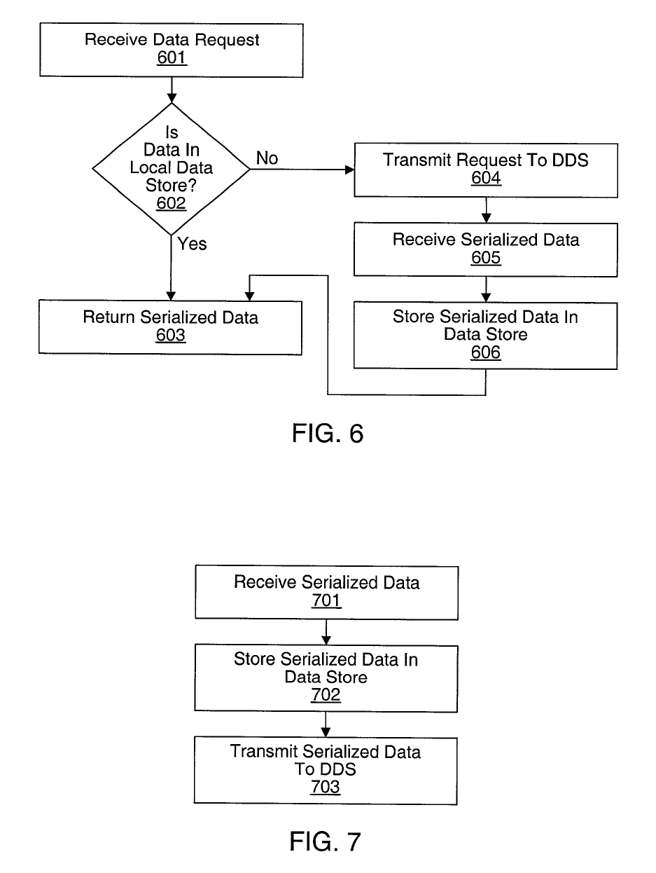

FIG. 6 and FIG. 7 are similar examples as FIGS. 4 and 5 for out-of-process clients. FIG. 6 is a flowchart illustrating an out-of-process distributed data manager handling a data request from one of its clients. Following FIG. 3, for example, a client 306B1 transmits a data request to the distributed data manager 302B, providing an indication of which data is requested from the distributed data system 300. The distributed data manager 302B receives the data request, as indicated at 601. The distributed data manager 302B then checks its data store 304B or some data structure containing information about the contents of the data store 304B to determine if the requested data is in the data store 304B, as indicated at 602. If the requested data is available locally, as indicated at 602, the distributed data manager 302B accesses and returns the requested data, as indicated at 603. Since the distributed data manager 302B is configured as out-of-process, the data in its data store 304B may be stored in a serialized format, thus reducing the amount of serialization in sending the response across process boundaries.

In the event that the requested data is not available locally, as indicated at 602, the distributed manager 302B transmits a data request for that data to other nodes in the distributed data system 300, as indicated at 604. For example, distributed data manager 302B transmits a data request to distributed data manager 306A of node A, as indicated at 604. If the requested data is in data store 304A, distributed data manager 302A returns that data to distributed data manager 302A of node A. Since node A is in-process, the data in data store 304A of distributed data manager 302A may be stored in a deserialized object format and therefore needs to be serialized before transmission. Distributed data manager 302B then receives the serialized data requested, as indicated at 605. Distributed data manager 302B stores the serialized data in its data store, as indicated at 606. Since the data is now available locally, the distributed data manager 302B and client 306B1 may proceed as described above, as indicated at 603.

The requested data may not be available from an in-process node in the distributed data system 300, as in the example above, but available from an out-of-process node. In the case of an out-of-process node responding to the request of another out-of-process node in the distributed data system the data does not need to be serialized before transmission. For example, if out-of-process distributed data manager 302B is receives a data request from another node, whether it is an out-of-process or an in-process node, distributed data manager 302B would transmit the data from its data store 304B. At least some of the data may be in serialized format already, reducing the serialization overhead, since it may be stored in serialized format and the transmission must cross a process boundary.

FIG. 7 is a flowchart illustrating an example of an out-of-process distributed data manager handling a request to store data from a client. Following FIG. 3, for example, an out-of-process client 306B1 transmits a data store request to the distributed data manager 302B, also transmitting the serialized data for storage since the client 306B1 and distributed data manager 302B do not share the same process space. The distributed data manager 302B receives the serialized data to be stored in the distributed data system 300, as indicated at 701. The distributed data manager 302B may then store “as is” the serialized data in its data store 304B, as indicated at 702. Some of the data received may not be stored or may not be in serialized format, for example messaging data used during the transmission of the requested data. Since the distributed data manager 302B is out-of-process, transmission of data in its data store crosses process boundaries. If replication is desired, the distributed data manager 302B then transmits the serialized data to at least another node in the distributed data system 300, as indicated at 703. Any other distributed data manager 302 receiving the serialized copy of the data may store that copy in their data store 304, depending on their own configuration. For example, an out-of-process distributed data manager 302 would store the data received “as is” in its data store 304 since it is configured out-of-process and the data is already serialized. Alternatively, distributed data manager 302C would deserialize the data received before storing it in its data store 304C.

Distributed data managers 302 may provide one or more distributed data functions. For example, the data store of a distributed data manager receiving a request to store data may not have room to store the entire data needing storage. In one embodiment a distributed data manager may de-allocate space used by other data to use for storing the new data needing storage. In that embodiment, a distributed data manager may ensure that at least one copy of data to be overwritten exists in another data store in the distributed data system. For example, the distributed data manager may communicate with other distributed data managers with copies of data to be overwritten by the distributed data manager to indicate that it will overwrite its local copy. Other distributed data managers may make additional copies of the data within the distributed system to ensure high availability. The distributed data manager may also send a copy of its local data to another distributed data manager in the distributed data system. These data communications may be performed for out-of-process and in-process nodes in a distributed data system as described above. In one embodiment, various other techniques for ensuring data preservation and high availability may be used.

In one embodiment, a distributed data manager may be implemented as a sessionStore on a computer with access to a network, for example the Internet. The data store may contain information regarding a user session, transactions between a server and client, or any data. In one embodiment, a client application may use a sessionStore implementation of a distributed data manager. In one embodiment, the client application and distributed data manager may function out-of-process. For example, an application server, a web server, both, or other Internet systems may function as clients to the distributed data manager, either on the same or different machines. Other applications or distributed data managers may be able to access the information stored in a relevant data store. In another node, a sessionStore may operate as the distributed data manager while sharing its process space with a web server process. In that embodiment, the distributed data manager may be considered in-process. Other applications such as an application server may interact with the web server through their own distributed data managers to get the relevant data. In one embodiment, a cluster may include a distributed data manager implemented as a sessionStore operating in-process on a server with a client application and a distributed data manager implemented as a sessionStore operating out-of-process on another server.

According to one embodiment of the present invention, additional nodes configured to operate within a distributed system either as in-process or out-of-process may join a distributed system including either or both of the in-process or out-of-process sessionStore distributed data manager. Also according to one embodiment, additional storage space may be added to the distributed system by including in the distributed system additional distributed data manager nodes. In one embodiment, a node in the distributed system may not have any clients but include a distributed data manager. That node may be considered out-of-process. In such an embodiment, all data in the node's data store is serialized since its communications of data would be across process boundaries. In one embodiment, a client node may operate in the distributed system without a distributed data manager, essentially functioning out-of-process. In such an embodiment, the client node may depend on another node and its distributed data manager for access to the distributed data system.

Various embodiments may further include receiving, sending or storing instructions and/or data implemented in accordance with the foregoing description upon a carrier medium. Generally speaking, a carrier medium may include storage media or memory media such as magnetic or optical media, e.g., disk or CD-ROM, volatile or non-volatile media such as RAM (e.g. SDRAM, DDR SDRAM, RDRAM, SRAM, etc.), ROM, etc. as well as transmission media or signals such as electrical, electromagnetic, or digital signals, conveyed via a communication medium such as network and/or a wireless link.

It will be appreciated by those of ordinary skill having the benefit of this disclosure that the illustrative embodiments described above are capable of numerous variations without departing from the scope and spirit of the invention. Various modifications and changes may be made as would be obvious to a person skilled in the art having the benefit of this disclosure. It is intended that the following claims be interpreted to embrace all such modifications and changes and, accordingly, the specifications and drawings are to be regarded in an illustrative rather than a restrictive sense.

What is claimed is:

1. A distributed data system, comprising:
a plurality of nodes coupled together, wherein each one of the plurality of nodes is coupled to at least one other one of the plurality of nodes for communicating data between the nodes, wherein the plurality of nodes comprises:
at least one in-process node comprising:
an in-process client; and
and a distributed data manager, wherein the in-process client and the distributed data manager for the in-process node are configured to execute within the same computer process on the in-process node, and wherein the distributed data manager for the in-process node is configured to communicate data with the in-process client in a non-serialized format and communicate data with other ones of the plurality of nodes in a serialized format; and
at least one out-of-process node comprising an out-of-process client, wherein the out-of-process client is configured to execute within a different process than any distributed data manager, and wherein the out-of-process client is configured to communicate data with other processes or other ones of the nodes in a serialized format.

2. The system as recited in claim 1, wherein the in-process client is configured to request data from the distributed data manager for the in-process node, and wherein, in response to the client's request, the distributed data manager for the in-process node is configured to return a reference to an object for the data without serializing the data.

3. The system as recited in claim 2, wherein the distributed data manager for the in-process node is configured to receive a request for data from another node, serialize the requested data and send the serialized data to the requesting node.

4. The system as recited in claim 1, wherein the distributed data manager for the in-process node is configured to receive serialized data from another node, de-serialize the data and store the de-serialized data as an object.

5. The system as recited in claim 1, wherein said in-process client is configured to send an object reference for the data to the distributed data manager for the in-process node to store data in the in-process node.

6. The system as recited in claim 1, wherein all data store operations performed by the distributed data manager in the in-process node store data in a non-serialized object format in a data store of the in-process node.

7. The system as recited in claim 1, further comprising a distributed data manager for the out-of-process node, wherein the distributed data manager for the out-of-process node is configured to communicate data with other processes or other ones of the plurality of nodes in a serialized format.

8. The system as recited in claim 7, wherein the out-of-process client is configured to execute in a separate process and communicate data with the distributed data manager for the out-of-process node in a serialized format.

9. The system as recited in claim 7, wherein the out-of-process client is configured to request data from the distributed data manager for the out-of-process node, and wherein, in response to the client's request, the distributed data manager for the out-of-process node is configured to send the requested data to the out-of-process client in a serialized format.

10. The system as recited in claim 7, wherein said out-of-process client is configured to send serialized data to the distributed data manager for the out-of-process node to store data to the distributed data manager for the out-of-process node, wherein the distributed data manager for the out-of-process node is configured to store the data in its serialized format.

11. The system as recited in claim 7, wherein the distributed data manager for the out-of-process node is configured to receive serialized data from another node, and store the data in its serialized format.

12. The system as recited in claim 7, wherein all data store operations performed by the distributed data manager for the out-of-process node store data in a serialized format in a data store of the out-of-process node.

13. The system as recited in claim 7, wherein the distributed data manager for the out-of-process node is configured to replicate data to one or more other ones of the plurality of nodes.

14. The system as recited in claim 7, wherein the distributed data manager for the out-of-process node is comprised within an application server, and wherein the out-of-process client is a web server coupled to the application server.

15. The system as recited in claim 1, wherein the distributed data manager for the in-process node is configured to replicate data stored in the in-process node to one or more other ones of the plurality of nodes.

16. The system as recited in claim 1, wherein the distributed data manager for the in-process node is comprised within an application server, and wherein the in-process client is a web server coupled to the application server.

17. A method, comprising:
an in-process client requesting data from a distributed data manager for an in-process node of a distributed data system, wherein the in-process client and the distributed data manager for the in-process node execute within the same process on the in-process node;
if the requested data is present in a data store managed by the distributed data manager for the in-process node:
the distributed data manager for the in-process node returning the requested data to the in-process client as an object without serializing the data;
if the requested data is not present in the data store managed by the distributed data manager for the in-process node:
the distributed data manager for the in-process node retrieving the requested data in a serialized format from another node of the distributed data system;
the distributed data manager for the in-process node de-serializing the data retrieved from another node into an object; and
the distributed data manager for the in-process node returning the requested data to the in-process client as the de-serialized object;
an out-of-process client requesting data from a node within the distributed data system; and
the out-of-process client receiving the requested data in a serialized format.

18. The method as recited in claim 17, further comprising:
the distributed data manager for the in-process node receiving a request for data from another node;
the distributed data manager for the in-process node serializing the requested data; and
the distributed data manager for the in-process node sending the serialized data to the requesting node.

19. The method as recited in claim 17, further comprising the distributed data manager for the in-process node receiving serialized data from another node, de-serializing the data and storing the de-serialized data as an object.

20. The method as recited in claim 17, further comprising said in-process client sending an object reference for the data to the distributed data manager for the in-process node for storing data in the in-process node.

21. The method as recited in claim 17, wherein all data store operations performed by the distributed data manager in the in-process node comprise storing data in a non-serialized object format in a data store of the in-process node.

22. The method as recited in claim 17, wherein the node within the distributed data system from which the out-of-process client requests data is configured as an out-of-process node comprising a distributed data manager, wherein the distributed data manager for the out-of-process node is configured to communicate data with other processes or other nodes of the distributed data system in a serialized format.

23. The method as recited in claim 22, further comprising the out-of-process client executing in a separate process and communicating data with the distributed data manager for the out-of-process node in a serialized format.

24. The method as recited in claim 22, further comprising:
the out-of-process client requesting data from the distributed data manager for the out-of-process node; and
the distributed data manager for the out-of-process node sending the requested data to the out-of-process client in a serialized format in response to the client's request.

25. The system as recited in claim 22, further comprising said out-of-process client storing data in the out-of-process node by sending serialized data to the distributed data manager for the out-of-process node, wherein the distributed data manager for the out-of-process node is configured to store the data in its serialized format.

26. The method as recited in claim 22, further comprising the distributed data manager for the out-of-process node receiving serialized data from another node, and storing the data in its serialized format.

27. The method as recited in claim 22, wherein all data store operations performed by the distributed data manager for the out-of-process node comprise storing data in a serialized format in a data store of the out-of-process node.

28. The method as recited in claim 22, further comprising the distributed data manager for the out-of-process node replicating data stored in the out-of-process node to other nodes of the distributed data system in a serialized format.

29. The method as recited in claim 22, wherein the distributed data manager for the out-of-process node is comprised within an application server, and wherein the out-of-process client is a web server coupled to the application server.

30. The method as recited in claim 17, further comprising the distributed data manager for the in-process node replicating data stored in the in-process node to other nodes of the distributed data system in a serialized format.

31. The method as recited in claim 17, wherein the distributed data manager for the in-process node is comprised within an application server, and wherein the in-process client is a web server coupled to the application server.

32. A method, comprising:
an out-of-process client requesting data from a distributed data manager for an out-of-process node of a distributed data system, wherein the out-of-process client and the distributed data manager for the out-of-process node execute in two distinct processes;
if the requested data is present in a data store managed by the distributed data manager for the out-of-process node:
the distributed data manager for the out-of-process node returning the requested data to the out-of-process client as a serialized object;
if the requested data is not present in the data store managed by the distributed data manager for the out-of-process node:
the distributed data manager for the out-of-process node retrieving the requested data in a serialized format from another node of the distributed data system; and
the distributed data manager for the out-of-process node returning the requested data in a serialized format to the out-of-process client;
an in-process client requesting data from a distributed data manager for an in-process node of the distributed data system, wherein the in-process client and the distributed data manager for the in-process node execute within the same process on the in-process node; and
the in-process client receiving the requested data in de-serialized format.

33. The method as recited in claim 32, further comprising the distributed data manager for the out-of-process node storing the data retrieved from another node in a serialized format in the data store managed by the distributed data manager for the out-of-process node.
